(19) United States
(12) Patent Application Publication
(10) Pub. No.: US 2016/0249316 A1
(43) Pub. Date: Aug. 25, 2016

(54) NON-LINE-OF-SIGHT (NLOS) AND LINE-OF-SIGHT (LOS) CLASSIFICATION TECHNIQUES FOR INDOOR RANGING

(71) Applicant: QUALCOMM Incorporated, San Diego, CA (US)

(72) Inventors: Shrinivas Shrikant KUDEKAR, Somerville, NJ (US); Jubin JOSE, Bound Brook, NJ (US); Xinzhou WU, Hillsborough, NJ (US); Thomas Joseph RICHARDSON, South Orange, NJ (US); Venkatesan Nallampatti Ekambaram, Somerville, NJ (US)

(21) Appl. No.: 14/631,699

(22) Filed: Feb. 25, 2015

(51) Int. Cl. H04W 64/00; G01S 5/02; H04W 24/08

(52) U.S. Cl. CPC H04W 64/00; H04W 24/08; G01S 5/0284

(57) ABSTRACT

Techniques for use in determining a position of a mobile device are provided in which a range estimate can be classified as a line-of-sight (LOS) range estimate or a non-line-of-sight (NLOS) range estimate and the range estimate and classification can be used to determine the position of the mobile device. A method according to these techniques includes determining channel impulse response (CIR) information based on at least one measurement of signals exchanged between the mobile device and another wireless device; classifying a range estimate representing an estimated distance between the mobile device and the other wireless device as a line-of-sight (LOS) range estimate or a non-line-of-sight (NLOS) range estimate based at least in part on the CIR information; and using the range estimate and the classification of the range estimate to determine the position of the mobile device.

### BACKGROUND

Non-Line of Sight (NLOS)/Line of Sight (LOS) classification is useful in indoor navigation/positioning and point-to-point (P2P) ranging applications, primarily to mitigate outliers. For indoor environments, the wireless channel between two wireless devices is a combination of direct path and indirect paths, resulting from multiple reflections, absorptions and scattering of the electromagnetic wave emitted from the transmitter. As a consequence the indoor channel could be modelled as a rich multipath faded environment. The primary goal of the ranging measurements is to provide a good estimate of the time of arrival of the first path. However, the first path could be subject to a number of impairments such as partial or total obstruction or the first path could be faded. Furthermore, the reflected paths could have higher energy than the first arrival path. As a consequence, any ranging algorithm based on detecting peak energy could potentially suffer from large errors in the range.

### SUMMARY

An example method for use in determining a position of a mobile device, the method being implemented at a computing platform, according to the disclosure includes determining channel impulse response (CIR) information based on at least one measurement of signals exchanged between the mobile device and another wireless device, classifying a range estimate representing an estimated distance between the mobile device and the other wireless device as a line-of-sight (LOS) range estimate or a non-line-of-sight (NLOS) range estimate based at least in part on the CIR information, and using the range estimate and the classification of the range estimate to determine the position of the mobile device.

Implementations of such a method may include one or more of the following features. Determining the range estimate representing the estimated distance between the mobile device and the other wireless device based on one or more measurements of signals exchanged between the mobile device and the other wireless device. The mobile device comprises the computing platform, and wherein determining the range estimate further includes: sending an round trip time (RTT) request to the other wireless device from the mobile device; and receiving an RTT response from the other wireless device at the mobile device; and wherein determining the CIR information based on the one or more measurements of signals exchanged between the mobile device and the other wireless device includes: determining the CIR information based on the RTT response received from the other wireless device. The RTT response received from the other wireless device comprises a second classification of the range estimate as a LOS range estimate or an NLOS range estimate. Determining a weighted range estimate classification based on the classification of the range estimate and the second classification of the range estimate received from the other wireless device. Classifying the range estimate includes classifying the range estimate as a LOS range estimate or a NLOS range estimate based on kurtosis of the CIR responsive to the estimated distance between the mobile device and the other wireless device being less than a predetermined distance threshold. Classifying the range estimate includes classifying the range estimate as the LOS range estimate responsive to the kurtosis being above a predetermined kurtosis threshold. Classifying the range estimate includes classifying the range estimate as a LOS range estimate or a NLOS range estimate based on kurtosis of the CIR and an exponent of a path loss responsive to the estimated distance between the mobile device and the other wireless device being less than a predetermined distance threshold. Determining the exponent of the path loss based on the CIR information. Determining a kurtosis-based classification and an exponent of the path loss-based classification. Associating a first weight with the kurtosis-based classification and a second weight with the exponent of the path loss-based classification, and determining the classification of the range estimate based on the kurtosis-based classification, the exponent of the path loss-based classification, the first weight, and the second weight. Comparing the exponent of the path loss to a predetermined threshold, and determining that the exponent of the path loss-based classification is LOS classification responsive to the exponent of the path loss being less than the predetermined threshold and path loss-based classification as NLOS responsive to the exponent of the path loss not being less than the predetermined threshold.

An apparatus for use in determining a position of a mobile device according to the disclosure includes means for determining channel impulse response (CIR) information based on at least one measurement of signals exchanged between the mobile device and another wireless device, means for classifying a range estimate representing an estimated distance between the mobile device and the other wireless device as a line-of-sight (LOS) range estimate or a non-line-of-sight (NLOS) range estimate based at least in part on the CIR information, and means for using the range estimate and the classification of the range estimate to determine the position of the mobile device.

An apparatus for use in determining a position of a mobile device according to the disclosure includes a processor configured to determine channel impulse response (CIR) information based on at least one measurement of signals exchanged between the mobile device and another wireless device, classify a range estimate representing an estimated distance between the mobile device and the other wireless device as a line-of-sight (LOS) range estimate or a non-line-of-sight (NLOS) range estimate based at least in part on the CIR information, and use the range estimate and the classification of the range estimate to determine the position of the mobile device.

Implementations of such an apparatus may include one or more of the following features. The processor being configured to classify the range estimate is further configured to classify the range estimate as a LOS range estimate or a NLOS range estimate based on kurtosis of the CIR responsive to the estimated distance between the mobile device and the other wireless device being less than a predetermined distance threshold. The processor being configured to classify the range estimate is further configured to classify the range estimate as a LOS range estimate or a NLOS range estimate based on kurtosis of the CIR and an exponent of a path loss responsive to the estimated distance between the mobile device and the other wireless device being less than a predetermined distance threshold. The processor is further configured to determine a kurtosis-based classification and an exponent of the path loss-based classification; associate a first weight with the kurtosis-based classification and a second weight with the exponent of the path loss-based classification, and determine the classification of the range estimate based on the kurtosis-based classification, the exponent of the path loss-based classification, the first weight, and the second weight.

An example non-transitory, computer-readable medium, having stored thereon computer-readable instructions for use in determining a position of a mobile device according to the disclosure includes instructions configured to cause a computer to determine channel impulse response (CIR) information based on at least one measurement of signals exchanged between the mobile device and another wireless device, classify a range estimate representing an estimated distance between the mobile device and the other wireless device as a line-of-sight (LOS) range estimate or a non-line-of-sight (NLOS) range estimate based at least in part on the CIR information, and use the range estimate and the classification of the range estimate to determine the position of the mobile device.

Implementations of such a non-transitory, computer-readable medium may include one or more of the following features. The instructions configured to cause the computer to classify the range estimate include instructions configured to cause the computer to classify the range estimate as a LOS range estimate or a NLOS range estimate based on kurtosis of the CIR responsive to the estimated distance between the mobile device and the other wireless device being less than a predetermined distance threshold. The instructions configured to cause the computer to classify the range estimate include instructions configured to cause the computer to classify the range estimate as a LOS range estimate or a NLOS range estimate based on kurtosis of the CIR and an exponent of a path loss responsive to the estimated distance between the mobile device and the other wireless device being less than a predetermined distance threshold. Instructions configured to cause the computer to determine a kurtosis-based classification and an exponent of the path loss-based classification, associate a first weight with the kurtosis-based classification and a second weight with the exponent of the path loss-based classification, and determine the classification of the range estimate based on the kurtosis-based classification, the exponent of the path loss-based classification, the first weight, and the second weight.

### BRIEF DESCRIPTION OF THE DRAWINGS

FIG. 1 is a block diagram of an example network architecture, which may be suitable for an implementing the techniques discussed herein.

FIG. 2 is a block diagram of a mobile device that can be used to implement the mobile device illustrated in FIG. 1.

FIG. 3 is a functional block diagram of the mobile device illustrated in FIG. 2 that illustrates functional modules of the mobile device.

FIG. 4 is a flow diagram of a process for use in determining a position of a mobile device according to the techniques discussed herein.

FIG. 5 is a flow diagram of a process for determining a range estimate according to the techniques discussed herein.

FIG. 6 is a flow diagram of a process for determining a range estimate according to the techniques discussed herein.

FIG. 7 is a flow diagram of a process for determining channel impulse response (CIR) information according to the techniques discussed herein.

FIG. 8 is a flow diagram of a process for classifying a range estimate according to the techniques discussed herein.

FIG. 9 is a flow diagram of a process for classifying a range estimate according to the techniques discussed herein.

FIG. 10 is a flow diagram of a process for classifying a range estimate according to the techniques discussed herein.

FIG. 11 is a flow diagram of a process for classifying a range estimate according to the techniques discussed herein.

### DETAILED DESCRIPTION

Techniques are disclosed herein for classifying a range estimate between a mobile device and another wireless device as a LOS range estimate or a NLOS range estimate. The other wireless device may be a wireless access point, wireless base station, or other wireless transmitter or another mobile device. The range estimate and the classification can be of use in determining a position of the mobile device. The classification can be a hard or a soft classification as to whether the range estimate is a LOS range estimate or a NLOS range estimate. The soft classification can include a confidence value with the classification information that provides an estimate of the reliability of the classification.

The classification techniques provided herein can use channel impulse response (CIR) data. The classification can be formed one or more of the following set of features and then running a classifier on the obtained features: (a) kurtosis: normalized (with respect to second moment) fourth moment of the CIR; (b) energy: the exponent of the path loss; (c) rise time: the time between the first peak above the noise threshold and the largest peak; and (d) delay spread: the time between the first peak above the noise threshold and the last peak above the noise threshold. The classifier may be configured to take all four of the above-referenced features into consideration. In other implementations, the classifier can be configured to take a subset of these features into consideration. One example implementation takes into account kurtosis and path loss to determine whether a measurement is NLOS or LOS.

These techniques can be adapted for use with Round Trip Time (RTT) range determination techniques, and can thereby be used to improve performance of the measurement engine of a mobile device. The RTT response can include an NLOS/LOS classification and may include a confidence value associated with the classification (for soft classifications). The receiving device can use the classification information in determining its position and/or combine the results from a classification made on the receiving device to increase classification accuracy.

### Example Network Environment

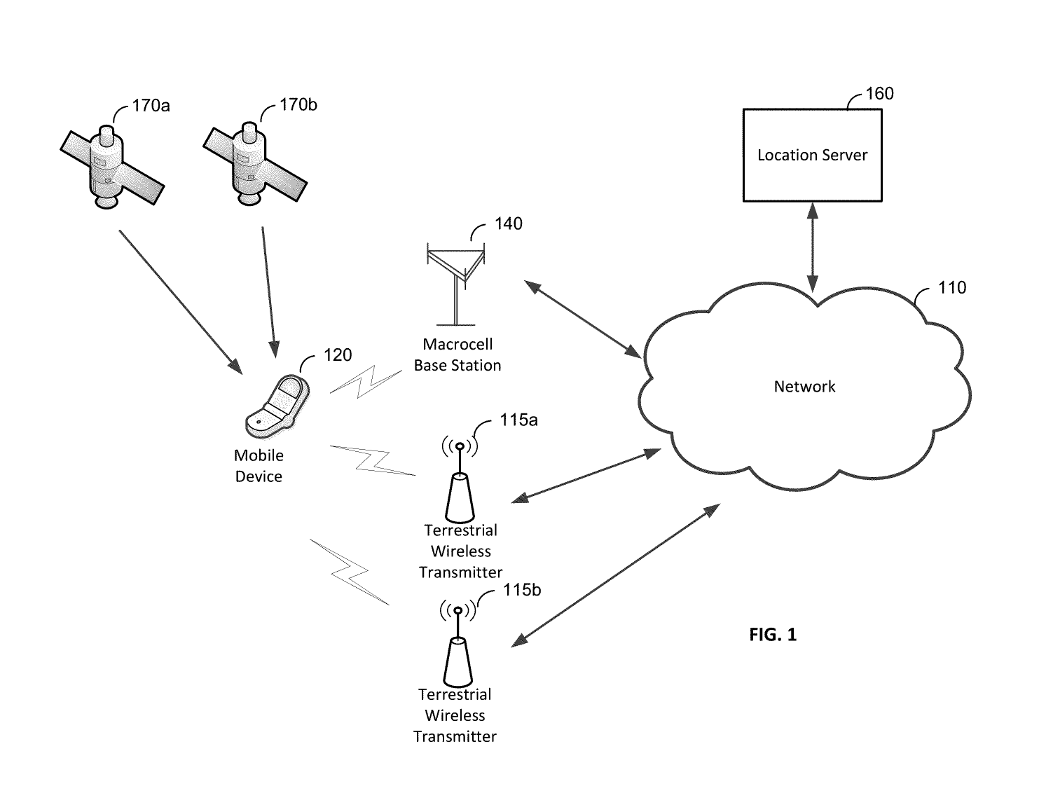

FIG. 1 is a block diagram of an example network architecture, which may be suitable for an implementing the techniques discussed herein. The particular configuration illustrated herein is merely an example of one network configuration in which the techniques disclosed herein may be used. Furthermore, an implementation of such a network architecture may include additional elements that are not illustrated herein and have been omitted for the sake of clarity.

The mobile device 120 may also be referred to as a User Equipment (UE), a mobile station, a terminal, an access terminal, a subscriber unit, a station, etc. The mobile device 120 may be a smartphone, a tablet computer, a laptop computer, or other device that includes a wireless transmitter that is configured to communicate using one or more wireless communications protocols, including, but not limited to, the Long Term Evolution (LTE), WiFi, and WiMAX wireless communications protocols. The mobile device 120 can also be configured to support other types of wireless communications protocols and can be configured to support multiple different wireless communications protocols. The wireless transmitter of the mobile device 120 can be configured to send data to and/or receive data from other mobile devices 120, the wireless transmitters 115, and/or one or more wireless base stations 140.

The mobile device 120 can also be configured to measure signals from one or more wireless base stations or wireless access points, such as the terrestrial wireless transmitters 115 and the wireless base station 140, and obtain timing measurements (e.g., for time of arrival (TOA) or observed time difference of arrival (OTDOA)), signal strength measurements (e.g., Receive Signal Strength Indication (RSSI)), RTT (round-trip time) and/or signal quality measurements for the wireless base stations. The pseudo-range measurements, timing measurements, signal strength measurements, and/or signal quality measurements may be used to derive a location estimate for the mobile device 120. A location estimate may also be referred to as a position estimate, a position fix, etc. Two terrestrial wireless transmitters are illustrated in this example: 115a and 115b. However, in other implementations, more or less wireless transmitters 115 may be included. The mobile device 120 can also be configured to use a combination of signals from one or more of the satellites 170, the wireless base station 140, and/or the wireless transmitters 115 to determine a position of the mobile device 120.

Each of the wireless transmitters 115 can comprise a WLAN wireless access point configured to operate using the IEEE 802.11 wireless communication standards. But, in some implementations some or all of the wireless transmitters 115 may be configured to utilize other wireless communications protocols, and some network environments may include a more than one type of wireless transmitter 115. Furthermore, while the wireless transmitters 115 are identified as transmitters, the wireless transmitters 115 may be transceivers configured to send and/or receive data wirelessly. The wireless transmitters 115 can be connected to network 110 via a backhaul connection that provides a broadband connection to the network 110. The network 110 may be the Internet and/or a combination of one or more networks. For example, the wireless transmitter 115 may be connected to a DSL modem or a cable modem, depending upon the type of broadband service being used in that particular implementation. A wireless transmitter 115 can be associated with a mobile communication network provider and can be configured to communicate with the mobile communication network provider's network (not shown) via the network 110. The coverage area of the a wireless transmitter 115 may overlap with that of one or more macrocell base stations, such as wireless base station 140, or that of one or more other terrestrial transceivers.

The wireless base station 140 can be configured to provide wireless network connectivity to a plurality of mobile devices 120. The wireless base station 140 may comprise a macrocell base station or other type of base station. The wireless base station 140 may have a much larger coverage area than the terrestrial transceiver 115 or may be a terrestrial transceiver that provides a coverage area that is of a similar size or of a smaller size than the coverage area provided by the terrestrial transceiver 115. Wireless base station 140 can be configured to communicate using one or more wireless communications protocols. While the example illustrated in FIG. 1 includes on a single wireless base station 140, in other implementations the network environment is likely to include more than wireless base station 140 which have coverage areas that may overlap at least in part.

The mobile device 120 can be configured to include a Global Navigation Satellite System (GNSS) receiver configured to receive and measure signals from one or more satellites 170, such as satellites 170a and 170b, and to obtain pseudo-range measurements for the satellites 170. Satellites 170 may be part of a Global Navigation Satellite System (GNSS), which may be the United States Global Positioning System (GPS), the European Galileo system, the Russian GLONASS system, or some other GNSS. The GNSS receiver may also be configured to detect and receive signals from satellites 170 belonging to more than one GNSS system. For example, satellite 170a could belong to the GPS system while the satellite 170b could belong to the Galileo system. While the example network architecture illustrated herein illustrates only two satellites 170, other implementations may have more or less satellites available, may have satellites associated with one or more GNSS system, and the number of satellites visible to the mobile device 120 may depend upon the current geographical location of the mobile devices and the orbits of the satellites 170.

The location server 160 can be configured to provide location services to the mobile device 120. For example, the location server 160 can be configured to provide almanac information and/or other information that the mobile device 120 can use to determine the position of the mobile device 120. The location server 160 can also be configured to assist the mobile device 120 in determining the position of the mobile device 120. For example, the location server 160 can be configured to receive signal measurements of signals received at the mobile device 120 from wireless transmitters 115 and/or wireless base stations 140 and to determine a position of the mobile device 120 based on those signals. While the location server 160 is represented as a single entity in the example implementation illustrated in FIG. 1, the logical functions performed by the location server 160 discussed herein can be implemented by more than one network entity. In some implementations, the mobile device 120 can be configured to provide

The example network configuration illustrated in FIG. 1 is merely an example of one possible configuration of a network in which the techniques disclosed herein may be implemented. Other network configurations may include additional elements not illustrated in FIG. 1 and the various components may be interconnected in a different configuration than what is shown in FIG. 1.

### Example Hardware

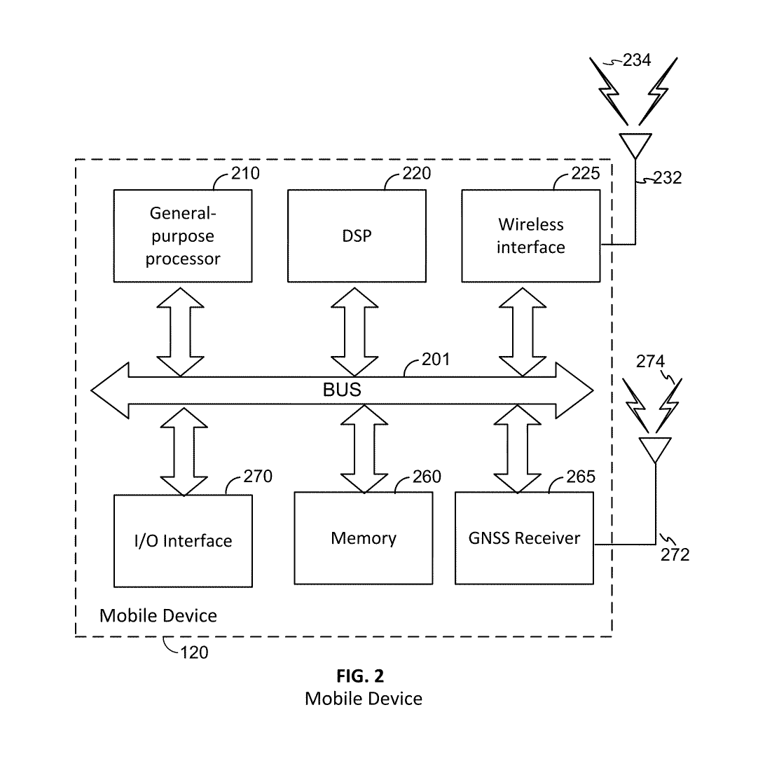

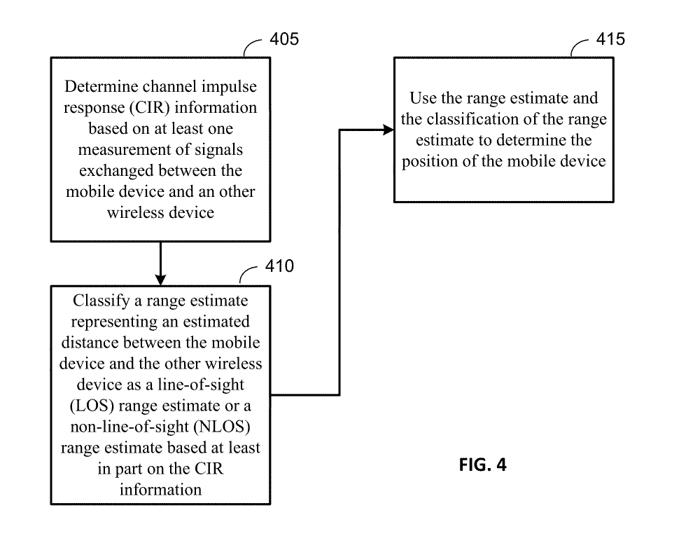

FIG. 2 is a block diagram of a mobile device that can be used to implement the mobile device 120 illustrated in FIG. 1. The mobile device 120 can be used to implement, at least in part, the processes illustrated in FIG. 4-10.

The mobile device 120 comprises a computer system including a general-purpose processor 210, a digital signal processor (DSP) 220, a wireless interface 225, a GNSS interface 265, and a non-transitory memory 260, connected to each other by a bus 201. Other implementations of the mobile device 120 may include additional elements not illustrated in the example implementation of FIG. 2 and/or may not include all of the elements illustrated in the example embodiment illustrated in FIG. 2. For example, some implementations of the mobile device 120 may not include the GNSS interface 265.

The wireless interface 225 can include a wireless receiver, transmitter, transceiver, and/or other elements that enable the mobile device 120 to send and/or receive data using WWAN, WLAN, and/or other wireless communication protocols. The wireless interface 225 can comprise one or more multi-mode modems capable of transmitting and receiving wireless signals using multiple wireless communications standards. The wireless interface 225 is connected by a line 232 to an antenna 234 for sending and receiving communications to/from the wireless transmitters 115, the wireless base station 140, and/or other wireless devices configured to communicate using wireless communication protocols. While the mobile device 120 illustrated in FIG. 2 comprises a single wireless interface 225 and a single antenna 234, other implementations of the mobile device 120 can include multiple modems 225 and/or multiple antennas 234.

I/O interface 270 can provide one or more ports and/or other interfaces that can provide for data inputs and/or outputs to the mobile device 120. For example, the I/O interface 270 can include one or more ports, such as a Universal Serial Bus (USB) port and/or other type of port that can be used to connect external devices to the mobile device. The I/O interface 270 can also include one or more input devices, such as buttons, switches, a keypad, a touchscreen and/or other means for receiving input from a user. The I/O interface 270 can also include one or more means for outputting audio and/or visual content, such as a screen, a speaker, a headphone port and/or other means for outputting such content.

The GNSS interface 265 can include a wireless receiver and/or other elements that enable the mobile device 120 to receive signals from transmitters associated with one or more GNSS systems. The GNSS interface 265 is connected by a line 272 to an antenna 274 for receiving signals from the GNSS transmitters, such as the satellites 170 illustrated in FIG. 1. The mobile device 120 can be configured to use signals received from satellites associated with satellites and other transmitters associated with the GNSS systems to determine a position of the mobile device 120. The mobile device 120 can also be configured to use the signals received from the satellites and other transmitters associated with the GNSS systems in conjunction with signals received from wireless transmitters 115 and/or wireless base stations 140 to determine a position of the mobile device 120.

The DSP 220 can be configured to process signals received from the wireless interface 225 and/or the GNSS interface 265 and may be configured to process signals for or in conjunction with one or more modules implemented as processor-readable, processor-executable software code stored in memory 260 and/or can be configured process signals in conjunction with the processor 210.

The processor 210 can be an intelligent device, e.g., a personal computer central processing unit (CPU) such as those made by Intel® Corporation or AMD®, a microcontroller, an application specific integrated circuit (ASIC), etc. The memory 260 is a non-transitory storage device that can include random access memory (RAM), read-only memory (ROM), or a combination thereof. The memory 260 can store processor-readable, processor-executable software code containing instructions for controlling the processor 210 to perform functions described herein (although the description may read that the software performs the function(s)). The software can be loaded onto the memory 260 by being downloaded via a network connection, uploaded from a disk, etc. Further, the software may not be directly executable, e.g., requiring compiling before execution.

The software in the memory 260 is configured to enable the processor 210 to perform various actions, including implementing sending and/or receiving data from the wireless transmitters 115, the wireless base station 140, other mobile devices 120, and/or other devices configured for wireless communication.

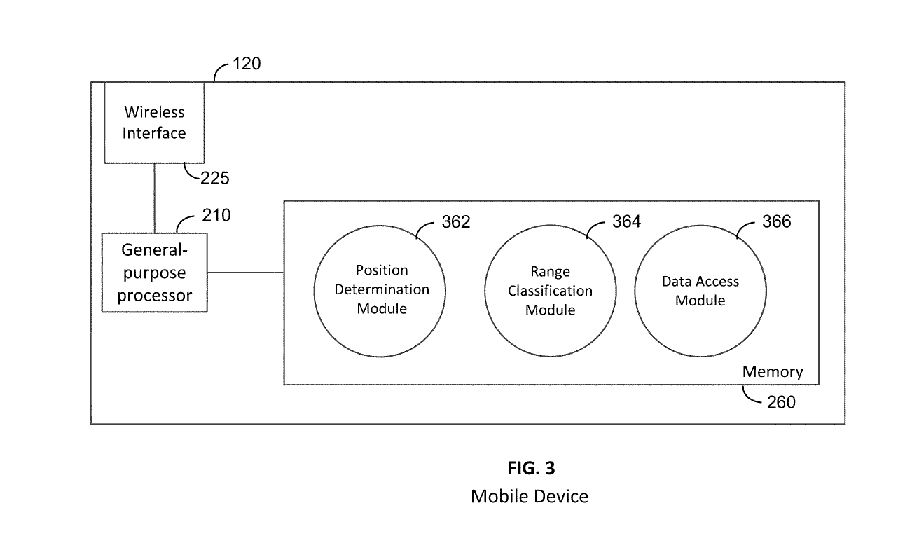

FIG. 3 is a functional block diagram of the mobile device 120 illustrated in FIG. 2 that illustrates functional modules of the memory 260 shown in FIG. 2. For example, the mobile device 120 can include a position determination module 362, a range classification module 364, and a data access module 366. The mobile device 120 may also include one or more additional functional modules that provide other functionality to the mobile device 120. The functional modules illustrated in FIG. 3 may be implemented as software as illustrated in FIG. 3 or may be implemented in hardware or a combination of hardware and software. The mobile device 120 illustrated in FIGS. 2 and 3 can be used to implement the mobile device 120 associated with the processes illustrated in FIGS. 4-10. The processor 210 can also provide means for implementing the various modules of the mobile device 120 discussed herein and may operate in conjunction with one or more modules implemented in firmware.

The position determination module 362 can be configured to determine a position of the mobile device 120. The position determination module 362 can provide means for determining the position of the mobile device based at least in part on signal measurements. For example, the position determination module 362 can be configured to receive pseudorange data from the GNSS interface 265 and use the pseudorange data to determine a position of the mobile device 120. The position determination module 362 can also be configured to request and receive almanac data from a network entity, such as the location server 160. The position determination module 362 can also be configured to use measurements of signals received from wireless base stations 140 and/or wireless transmitters 115 to determine a position of the mobile device 120. The position determination module 362 can also be configured to use pseudorange information from the GNSS interface 265 and measurements of signals received from wireless base stations 140 and/or wireless transmitters 115 to determine a position of the mobile device 120. The position determination module 362 can be configured to determine a position of the mobile device 120 by performing trilateration using signal measurements, RSSI (received signal strength indication), RTT (round-trip time)), time of arrival (TOA), to determine a position of the mobile device 120. The position determination module 362 can be configured to determine the position of the mobile device in response to a request from an application running on the mobile device, in response to an external entity, such as the location server 160, requesting a position of the mobile device, or in response to a request from another module of the mobile device. Furthermore, the wireless interface 225 can provide means for sending and/or receiving data and/or requests, except for GNSS signal data for which the GNSS receiver of the GNSS interface 265 can provide means for receiving such data.

The range classification module 364 can provide means for performing the various classification techniques discussed herein unless otherwise specified. The range classification module 364 can be configured to determine whether a range estimate between the mobile device 120 and another wireless device is an NLOS range estimate or a LOS range estimate based on various criteria. The other wireless device may be a wireless transmitter 115, another mobile device 120, or a wireless base station 140. The range classification module 364 can be configured to implement the processes illustrated in FIGS. 4-11 unless otherwise specified.

The data access module 366 can be configured to store data in the memory 260 and/or other data storage devices associated with the mobile device 120. The data access module 366 can also be configured to access data in the memory 260 and/or other data storage devices associated with the mobile device 120. The data access module 366 can be configured to receive requests from other modules and/or components of the mobile device 120 and to store and/or access data stored in the memory 260 and/or other data storage devices associated with the mobile device 120.

### Example Implementations

FIG. 4 is a flow diagram of a process for use in determining a position of a mobile device according to the techniques discussed herein according to the techniques discussed herein. The process illustrated in FIG. 4 can be implemented using the mobile device 120 illustrated in FIGS. 1-3, unless otherwise specified. The range classification module 364 and/or the position determination module 362 of the mobile device 120 can provide means for performing the various stages of the process illustrated in FIG. 4 unless otherwise specified.

Channel impulse response (CIR) information based on at least one measurement of signals exchanged between the mobile device 120 and another wireless device can be determined (stage 405). The other wireless device can be a terrestrial wireless transmitter 115, which may be implemented by a wireless access point or other wireless device. In some implementations, the other wireless device may be a mobile device 120, the position of which is known at the time that at least one measurement of the signals exchanged between the mobile device 120 and the other wireless device occurs.

A range estimate representing an estimated distance between the mobile device and the other wireless device can be classified as a line-of-sight (LOS) range estimate or a non-line-of-sight (NLOS) range estimate based at least in part on the CIR information (stage 410). The range estimate can be determined by the mobile device 120 and/or the other wireless device 120 with which the mobile device 120 exchanges signals in stage 405. The position determination module 362 and/or the range classification module 364 of the mobile device 120 can be configured to determine the estimated range between the mobile device and the other wireless device using various techniques. For example, the estimated range between the mobile device 120 and the other wireless device can be determined using RTT and/or TOA techniques. The other wireless device can also be configured to determine the range estimate and to send the range estimate to the mobile device 120 based on signals from the mobile device 120 received by the other wireless device.

The range estimate can be classified as a LOS range estimate or an NLOS range estimate by the other wireless device and/or the mobile device 120. For example, the range classification module 364 of the mobile device 120 can be configured to use the CIR data to classify the range estimate. The range classification module 364 can be configured to use one or more of the following features determined at least in part from the CIR information: (a) kurtosis: normalized (with respect to second moment) fourth moment of the CIR; (b) energy: the exponent of the path loss; (c) rise time: the time between the first peak above the noise threshold and the largest peak; and (d) delay spread: the time between the first peak above the noise threshold and the last peak above the noise threshold.

The range classification module 364 can be configured to classify the range estimate as an NLOS range estimate or a LOS range estimate based at least in part on the rise time. The range classification module 364 can be configured to classify the range estimate as LOS range estimate responsive to the rise time being less than a predetermined rise time threshold. The rise time can be expected to be reasonably high when the first path is not the main energy path and there is a time gap between the first path and the main energy path. This situation can occur when the LOS path between the mobile device 120 and the other wireless device is partially blocked. As a result, the LOS path may have a lower energy and a stronger reflected path may then arrive slightly later. In a situation where the LOS is not blocked, the rise time would be expected to be fairly small. Accordingly, where the rise time is less than a predetermined rise time threshold, the range classification module 364 can be configured to classify the range estimate as LOS range estimate.

The range classification module 364 can be configured to classify the range estimate as an NLOS range estimate or a LOS range estimate based at least in part on the delay spread. Where the range estimate is an NLOS range estimate, the signals between the mobile device 120 and the other wireless device are at least partially blocked and multiple reflections following the main reflection would be expected, resulting in a larger delay spread than would be expected for a LOS range estimate where such reflections are not expected. The range classification module 364 can be configured to classify the range estimate as LOS range estimate if the delay spread is less than a predetermined delay spread threshold.

The range classification module 364 can be configured to classify the range estimate as an NLOS range estimate or a LOS range estimate based at least in part on the kurtosis. The kurtosis of the CIR will typically be a larger number, denoting a sharp peak around the main energy peak, for LOS channels. The kurtosis of the CIR will typically be a smaller number, denoting a relatively fatter main peak or even a peak that is skewed to the right, for NLOS channels. The range classification module 364 can be configured to classify the range estimate as a LOS range estimate if the kurtosis of the CIR exceeds a predetermined kurtosis threshold and an NLOS estimate otherwise.

The range classification module 364 can be configured to classify the range estimate as an NLOS range estimate or a LOS range estimate based at least in part on the exponent of the path loss. The exponent of the path loss represents the normalized energy associated with signal received at the mobile device 120. The exponent of the path loss is normalized with respect to distance and should typically be larger for NLOS range estimates than for LOS range estimates. The path loss can be computed if the transmit power and the antenna gains are known. The transmitting device can be configured to include this information in a packet that is transmitted to the receiving device that is configured to determine the classification. For example, the mobile device 120 can be configured to transmit this information in a packet, such as an RTT request, to the other wireless device and the other wireless device can be configured to use this information to determine the path loss. Similarly, the other wireless device can be configured to include this information in a packet transmitted to the mobile device 120, such as an RTT response, and the range classification module 364 can be configured to use this information to determine the path loss exponent. The distance between the mobile device 120 and the other wireless device can be estimated (dist). The path loss exponent can be calculated using the following formula: P_{R}=C−10α log dist, where P_{R} represents the path loss in decibels (dB), C is a constant comprising the transmit power, the antenna gains, and other free-space constants, and a is the path-loss exponent, and dist is the estimated distance between the mobile device 120 and the other wireless device. The path loss exponent can be determined by determining the path loss from the CIR information and the distance from the estimate distance between the mobile device 120 and the other wireless device. The value of the path loss exponent can then be determined by solving for the value of α. The range classification module 364 can be configured to compare the path loss exponent to an expected LOS path-loss component for an indoor environment and an expected NLOS path-loss component for an indoor environment, and to classify the range estimate as NLOS or LOS based on whether the value of a is closer to the expected LOS path-loss component or the expected NLOS path-loss component. For example, the expected NLOS path-loss component may be set to value of approximately 3 for a typical indoor environment and the expected LOS path-loss component may be set to a value of approximately 1.6 for a typical indoor environment. If the exponent of the path-loss is determined to be 1.8 for a particular range estimate, the range classification module 364 can be configured to classify the range estimate as a LOS range estimate, because the value of the path-loss component is closer to the expected LOS path-loss exponent for this example scenario. The values of the expected NLOS path-loss component and the expected LOS path-loss component may vary for different indoor environments.

The range classification module 364 can be configured to take all four of the above-referenced features into consideration. For example, the range classification module 364 can be configured to determine each of the four features discussed above and/or additional or other features. In other implementations, the classifier can be configured to take a subset of these features into consideration. One example implementation takes into account kurtosis and path loss to determine whether a range estimate is an NLOS range estimate or a LOS range estimate.

The range classification module 364 can be configured to determine an NLOS range estimate or a LOS range estimate for the range estimate based on each of the features determined from the CIR information. The range classification module 364 can be configured to apply a weight to each of the features used to classify the range estimate to generate a weighted classification. The range classification module 364 can be configured to apply an equal weight to each of the features used to determine the weighted classification or can be configured apply different weights to different features. The weights can be used to provide a soft classification of the range estimate.

The range classification module 364 can be configured to determine a confidence level that the range classification module 364 has in a particular classification of a range estimate as a NLOS range estimate or a LOS range estimate. The range classification module 364 can be configured to determine a confidence level associated with the classification based on the weights. For example, if the range classification module 364 has determined a weighted range classification where a first factor is associated with a weight of 0.25 and the range classification associated with the first factor is indicative that the range estimate is an NLOS range estimate, while a second factor is associated with a weight of 0.75 and is indicative that the range estimate is a LOS range estimate, the range classification module 362 can be configured to provide generate a soft classification with a confidence level indicative that the range estimate is 75% likely to be a LOS range estimate and 25% likely to be a NLOS range estimate. In this scenario, if the range classification module 362 were configured to provide a hard classification, the range classification module 364 could be configured to determine that the range estimate is a LOS range estimate based on the weights associated with each of the factors. The particular weights associated with the factors in the example are intended to demonstrate the concepts discussed herein and are not intended to limit the weights that the range classification module 374 can associate with different factors used to classify the range estimate to these particular values.

The range estimate and the classification of the range estimate can be used to determine the position of the mobile device (stage 415). The range estimate and the classification of the range estimate can be passed to the position determination module 362 of the mobile device 120 which can be configured determine a position of the mobile device 120. The position determination module 362 can be configured to use the range estimate and the classification of the range estimate to determine the position of the mobile device in addition to other range estimates and classifications of range estimates provided by the range classification module 364. The range classification module 364 can be configured to provide the range estimate or range estimates to the position determination module 362 in response to a request from the position determination module 362 associated with one or more wireless devices proximate to the mobile device 120. The position determination module 362 can be configured to discard one or more range estimates based on the range classification and/or a confidence level associated with the range classifications. For example, if the position determination module 362 has received enough range estimates to determine a position of the mobile device based on LOS range estimates, the position determination module can be configured to discard the NLOS range estimates and/or to weight them less when determining a position of the mobile device 120. Furthermore, the position determination module 362 can be configured to use the range estimate or estimates in conjunction with other sources of information, such as measurements collected from one or more GNSS satellites and/or other sources of information that can be used to determine the location of the mobile device, such as the location server 160.

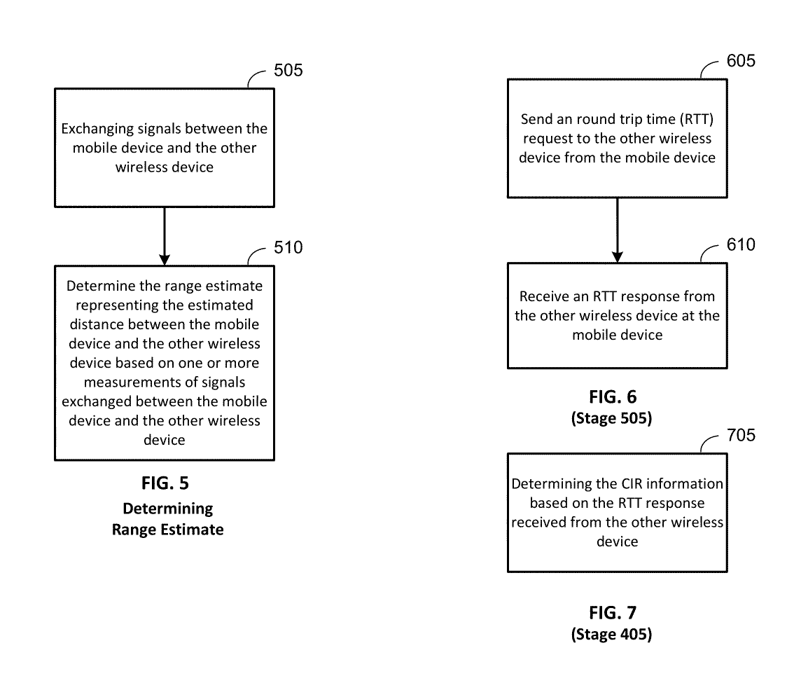

FIG. 5 is a flow diagram of a process for determining a range estimate according to the techniques discussed herein. The process illustrated in FIG. 5 can be implemented using the mobile device 120 illustrated in FIGS. 1-3, unless otherwise specified. The range classification module 364 of the mobile device 120 can provide means for performing the various stages of the process illustrated in FIG. 5 unless otherwise specified. The process illustrated in FIG. 5 can be used to determine the range estimate used in the process illustrated in FIG. 4.

Signals can be exchanged between the mobile device 120 and the other wireless device (stage 505). The mobile device 120 can use various techniques for determining a range estimate between the mobile device 120 and the other wireless device. For example, the range classification module 364 can be configured to use RTT to determine the range estimate between the mobile device 120 and the other wireless device. The range classification module 364 can be configured to determine the range estimate in response to a request from the position determination module 362. To obtain the range estimate using RTT, the range classification module 364 can be configured to send a request packet to another wireless device via the wireless interface 225 of the mobile device 120. The other wireless device can be another mobile device 120, a wireless transmitter 115, or a base station 140 at a known location. The other wireless device can then send a response packet in response to receiving the request packet from the mobile device 120. The request packet can comprise a WiFi probe request packet that includes the Service Set Identifier (SSID) of a wireless transmitter 115 to solicit a response from that wireless transmitter. Other types of request packets and wireless communication protocols can be used for sending and/or receiving the request and response packets.

A range estimate representing the estimated distance between the mobile device and the other wireless device can be determined based on one or more measurements of signals exchanged between the mobile device and the other wireless device (stage 510). The range estimate can be determined based on the signals exchanged between the mobile device 120 and the other wireless device 120. For example, the response packet received from the other wireless device can include a time of arrival of the request packet at the other wireless device and a time that the response packet was sent back to the mobile device 120 from the other wireless device. The mobile device 120 can receive the response packet via the wireless interface 225 and process the response packet to determine the round trip time between the mobile device 120 and the other wireless device. The position determination module 362 and/or the range classification module 364 of the mobile device 120 can be configured to determine the RTT between the two devices and can also be configured to determine and remove a processing time of the other wireless device to process the request from the mobile device 120 and to send the response packet to provide a more accurate range estimate.

The range classification module 364 of the mobile device and/or the other wireless device can also be configured to use other techniques, such as TOA and/or OTDOA to determine the range estimate between the mobile device 120 and the other wireless device.

In implementations where a response packet is received from the other wireless device, the response packet can include a classification of whether the signals received at the other wireless device were believed to be LOS or NLOS. The other wireless device can be configured to use the same or similar techniques as those discussed herein for classifying whether the signals received at the other wireless device were LOS or NLOS. For example, the request packet can include information such as the transmit power, the antenna gain, the time that the packet is sent, and/or other information that the other wireless device can used to estimate a range between the mobile device 120 and the other wireless device. The other wireless device can be configured to calculate the range estimate and hard or soft classification and to send the range estimate and the classification back to the mobile device 120. The other wireless device can be configured to send the range estimate and the classification to the wireless device with the response packet or as a separate transmission. The wireless interface 225 of the mobile device 120 can be configured to receive the response packet, the range estimate, and the classification sent by the other wireless device and to provide that information to the range classification module 364. The range classification module 364 can be configured to use the range classification received from the other wireless device in addition to or instead of a range estimate and classification determined by the range classification module 364. The range classification module 364 can also be configured to weight the range estimate and classification received from the other wireless device and a range estimate and classification determined by the range classification module 364 to determine a weighted range estimate and classification that can of use in estimating the position of the mobile device 120.

FIG. 6 is a flow diagram of a process for determining a range estimate according to the techniques discussed herein. The process illustrated in FIG. 6 can be implemented using the mobile device 120 illustrated in FIGS. 1-3, unless otherwise specified. The range classification module 364 of the mobile device 120 can provide means for performing the various stages of the process illustrated in FIG. 6 unless otherwise specified. The process illustrated in FIG. 6 can be used to implement stage 505 of the process illustrated in FIG. 5.

A round trip time (RTT) request can be sent to the other wireless device from the mobile device 120 (stage 605). As discussed above with respect to FIG. 5, the range classification module 364 of the mobile device can be configured to use RTT techniques to determine a range estimate between the mobile device 120 and the other mobile device. The range classification module 364 of the mobile device 120 can be configured to send an RTT request to the other wireless device via the wireless interface 225 of the mobile device 120. The RTT request can comprise a probe request or other type of packet.

An RTT response can be received from the other wireless device at the mobile device 120 (stage 610). As discussed above, the other wireless device can send an RTTP response to the mobile device 120 in response to receiving the RTT request from the mobile device 120. The RTTP response can include a range estimate and a range classification determined by the other wireless device based on the RTT request received at the other wireless device.

The range classification module 364 can be configured to repeat the stages 605 and 610 multiple times to obtain multiple RTT range estimates. Each RTT response from the other wireless device can include a range estimate and a hard or soft classification whether the range estimate is a LOS range estimate or an NLOS range estimate. The range classification module 364 can also be configured to send multiple other types of requests for obtaining range estimates. The range classification module 364 can be configured to non-coherently combine the multiple range estimates and classifications received from the other wireless device to determine a classification of the range estimate between the mobile device 120 and the other wireless device. The range classification module 364 can be configured to utilize simple majority rule for determining whether the range estimate is an NLOS range estimate or a LOS range estimate. For example, if the range classification module 364 was configured to request five range estimates and classifications from the other wireless device, and three of the five range estimates received from the other wireless device are NLOS range estimates, then the range classification module 364 can be configured to determine that the range estimate is an NLOS range estimate. The range classification module 364 can also be configured to determine range estimates and range classifications of its own based on the responses received from the other wireless device. The range classification module 364 can be configured to weight the range estimate and classifications determined by the mobile device 120 and the other wireless device equally or may associate a higher weight with range estimates and range classifications determined by either the mobile device 120 or the other wireless device. The range classification module 364 can be configured to determine these weights at least based in part on the type of device of the other wireless device. For example, the range classification module 364 may be configured to assign a lower weight to range estimates and classifications received from the other wireless device if the other wireless device is another mobile device, but assign a higher weight to range estimate and range estimates received from wireless access points or wireless base stations. The range classification module 364 can also be configured to utilize reliability statistics for the wireless transmitters 115 and/or the wireless base stations 140 to determine the weight to assign to a range estimate obtained from a particular wireless transmitter 115 or wireless base station 140. The location server 160 can be configured to maintain such reliability information and the mobile device 120 can be configured to obtain the reliability information from the location server 160.

FIG. 7 is a flow diagram of a process for determining channel impulse response (CIR) information according to the techniques discussed herein. The process illustrated in FIG. 7 can be implemented using the mobile device 120 illustrated in FIGS. 1-3, unless otherwise specified. The range classification module 364 of the mobile device 120 can provide means for performing the various stages of the process illustrated in FIG. 7 unless otherwise specified. The process illustrated in FIG. 7 can be used to implement stage 405 of the process illustrated in FIG. 4.

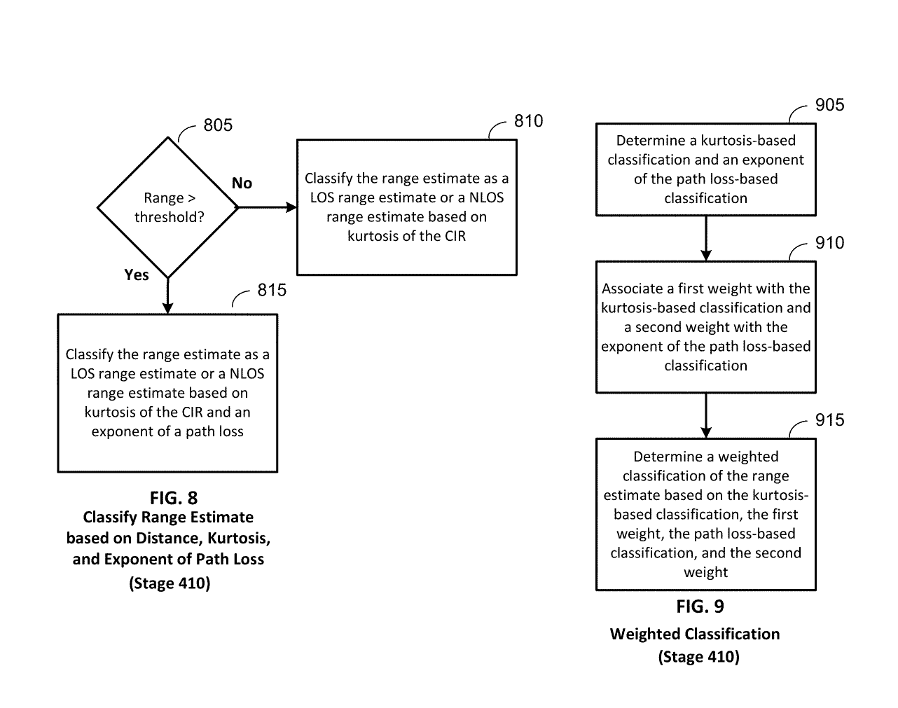

Determining the CIR information based on the RTT response received from the other wireless device (stage 705). The CIR information can be determined by the range classification module 364 of the mobile device and/or by other components or modules of the mobile device 120 in response to receiving the RTT response from the RTT response from the other wireless device. The range classification module 364 can use the CIR information when classifying the range estimate at the mobile device 120. Examples of such range classification techniques are illustrated in FIGS. 8-11.

FIG. 8 is a flow diagram of a process for classifying a range estimate according to the techniques discussed herein. The process illustrated in FIG. 8 can be implemented using the mobile device 120 illustrated in FIGS. 1-3, unless otherwise specified. The range classification module 364 of the mobile device 120 can provide means for performing the various stages of the process illustrated in FIG. 8 unless otherwise specified. The process illustrated in FIG. 8 can be used to implement stage 410 of the process illustrated in FIG. 4. The classification technique illustrated in FIG. 8 uses kurtosis and/or the exponent of the path loss to classify a range estimate as either an NLOS range estimate or an LOS range estimate. The process illustrated in FIG. 8 can be adapted to use other factors, such as those discussed above, in addition to the kurtosis and/or the exponent of the path loss when classifying the range estimate.

A determination whether the estimated range is greater than a range threshold can be made (stage 805). The range classification module 364 can be configured to use different factors for classifying a range estimate based on the distance that the mobile device 120 is from other wireless device. The range classification module 364 can use the range estimate to determine whether the mobile device 120 is more than a predetermined distance from the other wireless device and select which factors to consider when determining the classification of the range estimate based on those factors. If the distance between the mobile device 120 and the other device is not greater than the predetermined threshold distance, then the process continues with stage 810. Otherwise, the process continues with stage 815.

The range estimate can be classified as a LOS range estimate or a NLOS range estimate based on kurtosis of the CIR (stage 810). When the mobile device 120 is closer than the threshold distance from the other wireless device, the exponent of the path estimate may not be as accurate for classifying whether the range estimate is an NLOS range estimate or an LOS range estimate. Accordingly, the range classification module 364 can be configured to classify the range estimate using the kurtosis as discussed above where if the kurtosis exceeds a predetermined kurtosis threshold, the range classification module will classify the range estimate as LOS range estimate. Otherwise, the range classification module 364 can classify the range estimate as a NLOS range estimate. An example process for implementing a kurtosis-based classification is illustrated in FIG. 11.

The range estimate can be classified as a LOS range estimate or a NLOS range estimate based on kurtosis of the CIR and an exponent of a path loss (stage 815). The range classification module 364 can be configured to classify the range estimate using both the kurtosis of the CIR and the exponent of the path loss where the estimate distance between the mobile device 120 and the other wireless device exceeds the predetermined range threshold. The exponent of the path loss is likely to be more accurate for classifying the range estimate when the estimate range exceeds this predetermined threshold. An example process for implementing a kurtosis and exponent of the path loss-based classification is illustrated in FIG. 9. The range classification module 364 can be configured to weight the kurtosis and the exponent of the path loss equally when determining a classification of the range estimate or may be configured to weight one or the other of the factors more heavily than the other, and use the factor that is given higher weight as the deciding factor where the classification based on the kurtosis does not agree with the classification based the exponent of the path loss.

FIG. 9 is a flow diagram of a process for classifying a range estimate according to the techniques discussed herein. The process illustrated in FIG. 9 can be implemented using the mobile device 120 illustrated in FIGS. 1-3, unless otherwise specified. The range classification module 364 of the mobile device 120 can provide means for performing the various stages of the process illustrated in FIG. 9 unless otherwise specified. The process illustrated in FIG. 9 can be used to implement stage 410 of the process illustrated in FIG. 4 or stage 815 of the process illustrated in FIG. 8.

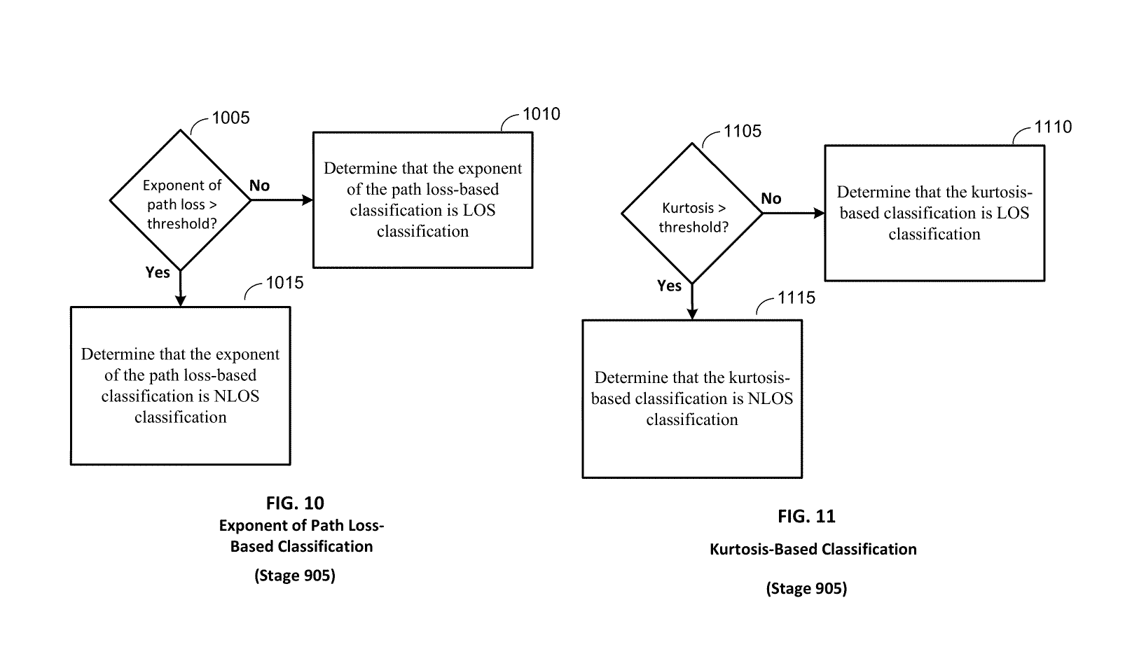

A kurtosis-based classification and an exponent of the path loss-based classification can be determined (stage 905). The classifications can be performed by the range classification module 364 using one or more of the techniques disclosed herein. For example, the process illustrated in FIG. 10 can be used to determine a path-loss based classification of the range estimate, and the process illustrated in FIG. 11 can be used to determine a kurtosis-based classification of the range estimate.

A first weight can be associated with the kurtosis-based classification and a second weight can be associated with the exponent of the path loss-based classification (stage 910). The range classification module 364 can be configured to apply a weight to each of the features used to classify the range estimate to generate a weighted classification. The range classification module 364 can be configured to apply an equal weight to each of the features used to determine the weighted classification or can be configured apply different weights to different features. The range classification module 364 can be configured such that the first weight associated with the kurtosis-based classification is greater than the second weight associated with the path loss-based classification. Alternatively, range classification module 364 can be configured such that the first weight associated with the kurtosis-based classification is less than the second weight associated with the path loss-based classification. For example, the first and second weights may be adjusted based on the range estimate obtained in stage 410 of the process illustrated in FIG. 4. The first weight associated with the kurtosis-based classification may be greater than the second weight associated with the path loss-based classification responsive to the range estimate being less than a first predetermined threshold distance. In some implementations, the first weight associated with the kurtosis-based classification may be weighted at 100% or at a predetermined percentage near 100% and the second weight associated with the path loss-based classification can be weighted at 0% or at a predetermined percentage near 0% responsive to the range estimate being less than a second predetermined threshold distance, where the second predetermined threshold distance is less than the first predetermined threshold distance. Such weightings may be used because the path loss-based classification may become less reliable as the range estimate becomes smaller.

A weighted classification of the range estimate can be determined based on the kurtosis-based classification, the first weight, the path loss-based classification, and the second weight (stage 915). The range classification module 364 can be configured such that if the kurtosis-based classification and the path loss-based classification are in agreement, the range classification module 364 can be configured to adopt the classification for the range estimate. Where the kurtosis-based classification and the path loss-based classification are not in agreement, the range classification module 364 can be configured to adopt the classification associated with the classification that is associated with a higher weight. The range classification module 364 can use the weights in such a situation to settle a discrepancy between the kurtosis-based classification and the path loss-based classification.

The range classification module 364 can be configured to obtain multiple range estimates and classifications as discussed above with respect to the process illustrated in FIG. 6, and the range classification module 364 can be configured to determine a weighted range classification for each of the range estimates and to determine an overall range classification and an overall range estimate of the distance between the mobile device 120 and the other wireless device. For example, the range classification module 364 can be configured to average the range estimates to determine an overall range estimate. The range classification module 364 can also be configured to select an overall range classification based whether a majority of the range classifications indicate that the range estimates are LOS range estimates or NLOS range estimates.

FIG. 10 is a flow diagram of a process for classifying a range estimate according to the techniques discussed herein. The process illustrated in FIG. 10 can be implemented using the mobile device 120 illustrated in FIGS. 1-3, unless otherwise specified. The range classification module 364 of the mobile device 120 can provide means for performing the various stages of the process illustrated in FIG. 10 unless otherwise specified. The process illustrated in FIG. 10 can be used to implement stage 410 of the process illustrated in FIG. 4 or stage 905 of the process illustrated in FIG. 9.

A determination can be made whether the exponent of the path loss is greater than a path loss threshold (stage 1005). The path loss threshold can be a value stored in the memory 260 of the mobile device 120 and the range classification module 364 can be configured to access the path loss threshold value from the memory 260 via the data access module 366. The path loss threshold can be defined for a particular environment in which the mobile device 120 is believed to be located. For example, different types of indoor environments may have different path loss thresholds associated with them based on the signal propagation characteristics typical of such an environment or based on actual signal measurements collected in the environment. The range classification module 364 of the mobile device 120 can be configured to obtain the path loss threshold information from the location server 160 responsive to the position determination module 362 determining that the mobile device 120 has entered a particular environment. The location server 160 can also be configured to push the path loss threshold information and other such information for an indoor environment to the mobile device 120 when the mobile device 120 enters the environment. The range classification module 364 can be configured to calculate the exponent of the path loss based in part on the CIR information determined in stage 405 and to classify the range estimate based on this information. An equation that can be used by the range classification module 364 to determine the exponent of the path loss is discussed in detail above. The path loss can be computed if the transmit power and the antenna gains are known. The transmitting device can be configured to include transmit power and the antenna gains in a packet that is transmitted to the receiving device that is configured to determine the classification. For example, the mobile device 120 can include this information in a ranging request packet sent to the other wireless device, and the other wireless device can use this to calculate the exponent of the path loss and to classify the range estimate. The other wireless device can also be configured to include the transmit power and the antenna gains in the ranging response packet sent in response to the ranging request, and the range classification module 364 can use this information to calculate the exponent of the path loss. The range classification module 364 can then compare exponent of the path loss to the path loss threshold to classify the range estimate.

The exponent of the path loss-based classification is determined to be a LOS range estimate (stage 1010). The range classification module 364 can be configured to determine that range estimate is a LOS range estimate in response to the exponent of the path loss not exceeding the kurtosis threshold value.

The exponent of the path loss-based classification is determined to be an NLOS range estimate (stage 1015). The range classification module 364 can be configured to determine that range estimate is a LOS range estimate in response to the exponent of the path loss exceeding the kurtosis threshold value.

FIG. 11 is a flow diagram of a process for classifying a range estimate according to the techniques discussed herein. The process illustrated in FIG. 11 can be implemented using the mobile device 120 illustrated in FIGS. 1-3, unless otherwise specified. The range classification module 364 of the mobile device 120 can provide means for performing the various stages of the process illustrated in FIG. 11 unless otherwise specified. The process illustrated in FIG. 11 can be used to implement stage 410 of the process illustrated in FIG. 4 or stage 905 of the process illustrated in FIG. 9.

A determination can be made whether the kurtosis of the CIR is greater than a kurtosis threshold (stage 1105). The kurtosis threshold can be a value stored in the memory 260 of the mobile device 120 and the range classification module 364 can be configured to access the kurtosis threshold value from the memory 260 via the data access module 366. The kurtosis threshold can be defined for a particular environment in which the mobile device 120 is believed to be located. For example, different types of indoor environments may have different kurtosis thresholds associated with them based on the signal propagation characteristics typical of such an environment or based on actual signal measurements collected in the environment. The range classification module 364 of the mobile device 120 can be configured to obtain the threshold information from the location server 160 responsive to the position determination module 362 determining that the mobile device 120 has entered a particular environment. The location server 160 can also be configured to push the kurtosis threshold information and other such information for an indoor environment to the mobile device 120 when the mobile device 120 enters the environment. The range classification module 364 can be configured to calculate the kurtosis of the CIR information determined in stage 405 and to classify the range estimate based on this information.

The exponent of the kurtosis-based classification is determined to be a LOS range estimate (stage 1110). The range classification module 364 can be configured to determine that range estimate is a LOS range estimate in response to the kurtosis of the CIR exceeding the kurtosis threshold value.

The exponent of the kurtosis-based classification is determined to be a NLOS range estimate (stage 1115). The range classification module 364 can be configured to determine that range estimate is an NLOS range estimate in response to the kurtosis of the CIR not exceeding the kurtosis threshold value.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for use in determining a position of a mobile device, the method comprising, at a computing platform:
determining channel impulse response (CIR) information based on at least one measurement of signals exchanged between the mobile device and another wireless device;
classifying a range estimate representing an estimated distance between the mobile device and the other wireless device as a line-of-sight (LOS) range estimate or a non-line-of-sight (NLOS) range estimate based at least in part on the CIR information; and
using the range estimate and the classification of the range estimate to determine the position of the mobile device.

2. The method of claim 1, further comprising
determining the range estimate representing the estimated distance between the mobile device and the other wireless device based on one or more measurements of signals exchanged between the mobile device and the other wireless device.

3. The method of claim 2, wherein the mobile device comprises the computing platform, and wherein determining the range estimate further comprises:
sending an round trip time (RTT) request to the other wireless device from the mobile device; and
receiving an RTT response from the other wireless device at the mobile device;
and wherein determining the CIR information based on the one or more measurements of signals exchanged between the mobile device and the other wireless device comprises:
determining the CIR information based on the RTT response received from the other wireless device.

4. The method of claim 3, wherein the RTT response received from the other wireless device comprises a second classification of the range estimate as a LOS range estimate or an NLOS range estimate.

5. The method of claim 4, further comprising determining a weighted range estimate classification based on the classification of the range estimate and the second classification of the range estimate received from the other wireless device.

6. The method of claim 1, wherein classifying the range estimate comprises classifying the range estimate as a LOS range estimate or a NLOS range estimate based on kurtosis of the CIR responsive to the estimated distance between the mobile device and the other wireless device being less than a predetermined distance threshold.

7. The method of claim 6, wherein classifying the range estimate comprises classifying the range estimate as the LOS range estimate responsive to the kurtosis being above a predetermined kurtosis threshold.

8. The method of claim 1, wherein classifying the range estimate comprises classifying the range estimate as a LOS range estimate or a NLOS range estimate based on kurtosis of the CIR and an exponent of a path loss responsive to the estimated distance between the mobile device and the other wireless device being less than a predetermined distance threshold.

9. The method of claim 8, further comprising determining the exponent of the path loss based on the CIR information and the range estimate.

10. The method of claim 8, further comprising determining a kurtosis-based classification and an exponent of the path loss-based classification.

11. The method of claim 10, further comprising:
associating a first weight with the kurtosis-based classification and a second weight with the exponent of the path loss-based classification; and
determining the classification of the range estimate based on the kurtosis-based classification, the exponent of the path loss-based classification, the first weight, and the second weight.

12. The method of claim 10, further comprising:
comparing the exponent of the path loss to a predetermined threshold; and
determining that the exponent of the path loss-based classification is LOS classification responsive to the exponent of the path loss being less than the predetermined threshold and path loss-based classification as NLOS responsive to the exponent of the path loss not being less than the predetermined threshold.

13. An apparatus for use in determining a position of a mobile device, the apparatus comprising:
a processor configured to
determine channel impulse response (CIR) information based on at least one measurement of signals exchanged between the mobile device and another wireless device;
classify a range estimate representing an estimated distance between the mobile device and the other wireless device as a line-of-sight (LOS) range estimate or a non-line-of-sight (NLOS) range estimate based at least in part on the CIR information; and
use the range estimate and the classification of the range estimate to determine the position of the mobile device.

14. The apparatus of claim 13, wherein the processor being configured to classify the range estimate is further configured to classify the range estimate as a LOS range estimate or a NLOS range estimate based on kurtosis of the CIR responsive to the estimated distance between the mobile device and the other wireless device being less than a predetermined distance threshold.

15. The apparatus of claim 13, wherein the processor being configured to classify the range estimate is further configured to classify the range estimate as a LOS range estimate or a NLOS range estimate based on kurtosis of the CIR and an exponent of a path loss responsive to the estimated distance between the mobile device and the other wireless device being less than a predetermined distance threshold.

16. The apparatus of claim 15, wherein the processor is further configured to:
determine a kurtosis-based classification and an exponent of the path loss-based classification;
associate a first weight with the kurtosis-based classification and a second weight with the exponent of the path loss-based classification; and
determine the classification of the range estimate based on the kurtosis-based classification, the exponent of the path loss-based classification, the first weight, and the second weight.

17. A non-transitory, computer-readable medium, having stored thereon computer-readable instructions for use in determining a position of a mobile device, comprising instructions configured to cause a computer to:
determine channel impulse response (CIR) information based on at least one measurement of signals exchanged between the mobile device and another wireless device;
classify a range estimate representing an estimated distance between the mobile device and the other wireless device as a line-of-sight (LOS) range estimate or a non-line-of-sight (NLOS) range estimate based at least in part on the CIR information; and
use the range estimate and the classification of the range estimate to determine the position of the mobile device.

18. The non-transitory, computer-readable medium of claim 17, wherein the instructions configured to cause the computer to classify the range estimate further comprise instructions configured to cause the computer to classify the range estimate as a LOS range estimate or a NLOS range estimate based on kurtosis of the CIR responsive to the estimated distance between the mobile device and the other wireless device being less than a predetermined distance threshold.

19. The non-transitory, computer-readable medium of claim 17, wherein the instructions configured to cause the computer to classify the range estimate further comprise instructions configured to cause the computer to classify the range estimate as a LOS range estimate or a NLOS range estimate based on kurtosis of the CIR and an exponent of a path loss responsive to the estimated distance between the mobile device and the other wireless device being less than a predetermined distance threshold.

20. The non-transitory, computer-readable medium of claim 19, further comprising instructions configured to cause the computer to:
determine a kurtosis-based classification and an exponent of the path loss-based classification;
associate a first weight with the kurtosis-based classification and a second weight with the exponent of the path loss-based classification; and
determine the classification of the range estimate based on the kurtosis-based classification, the exponent of the path loss-based classification, the first weight, and the second weight.
